(19) United States
(12) Patent Application Publication
(10) Pub. No.: US 2024/0371561 A1
(43) Pub. Date: Nov. 7, 2024

(54) ACTIVELY COOLED INDUCTOR

(71) Applicant: FORD GLOBAL TECHNOLOGIES, LLC, Dearborn, MI (US)

(72) Inventors: John P. Casci, Canton, MI (US); Baoming Ge, Okemos, MI (US); Fan Wang, Novi, MI (US)

(21) Appl. No.: 18/310,763

(22) Filed: May 2, 2023

(51) Int. Cl. H01F 27/10; H01F 27/24; H01F 27/32

(52) U.S. Cl. CPC H01F 27/10; H01F 27/24; H01F 27/325

(57) ABSTRACT

An electric drive system includes an actively cooled inductor. The inductor is formed by winding C-shaped wire around a bobbin such that channels are defined between the bobbin and the wire. After the bobbin is installed over the core, a plastic layer is injected between the core and the bobbin. This expands the bobbin against the wire to seal the channels and also to fasten the bobbin in place. A variety of porting arrangements are proposed to route cooling fluid through the channels to cool the windings and the core.

### TECHNICAL FIELD

The present disclosure relates to an inductor for an electric drive system. More particularly, it relates to an actively cooled inductor.

### BACKGROUND

An electric drive system includes a battery, a power electronics module, and a motor. The power electronics module includes a variable voltage converter that boosts the DC battery voltage to a higher DC voltage for use by an inverter. During operation, an inductor associated with the variable voltage may generate heat.

### SUMMARY

An inductor for an electric drive system includes a core, a bobbin, a winding, and an inlet port. The core is magnetically conductive. The bobbin encircles a section of the core. The bobbin may include spiral locating features. The winding is electrically conductive and encircles the bobbin. The winding and the bobbin define a channel therebetween. The winding may have a C-shaped cross section with an open side facing the bobbin. The inlet port is configured to direct fluid through the channel to cool the inductor. A plastic filler may be injected between the bobbin and the core. The plastic filler may exert radial pressure on the bobbin such that the winding is partially embedded into the bobbin to seal the winding against the bobbin.

An inductor for an electric drive system includes a core, first and second winding assemblies, and an electrical link. The core is magnetically conductive and has first and second straight sections. The first and second winding assemblies encircle the first and second straight sections respectively. Each winding assembly includes a bobbin and an electrically conductive winding. The bobbins may include spiral locating features. The windings are wrapped around the bobbins to define channels therebetween. The winding may have a C-shaped cross section with an open side facing the bobbin. A plastic filler may be injected between the bobbin and the core. Radial pressure exerted by the plastic filler may partially embed the windings into the bobbin to seal the winding against the bobbin. Each winding assembly may include an inlet port and an outlet port fluidly connected to the channel. The electrical link extends between the winding of the first winding assembly and the winding of the second winding assembly. The electrical link may define a channel which connects the channels of the first and second winding assemblies to one another.

An electric drive system includes a variable voltage converter, a sump, and a pump. The variable voltage converter has an inductor which includes a core, a first bobbin, a first winding, and a first inlet port. The core is magnetically conductive. The first bobbin encircles a first straight section of the core. The first electrically conductive winding is wrapped around the first bobbin to define a first channel therebetween. The first inlet port is fluidly connected to the first channel. A plastic filler may be injected between the first bobbin and the core. The plastic filler may exert radial pressure on the first bobbin to seal the first bobbin against the first winding. The pump is configured to draw fluid from the sump and route it to the first inlet port. The inductor may also include a second bobbin, a second electrically conductive winding, and an electrical link. The second bobbin may encircle a second straight section of the core. The second winding may be wrapped around the second bobbin defining a second channel therebetween. The electrical link may extend between the first winding and the second winding.

### BRIEF DESCRIPTION OF THE DRAWINGS

FIG. 1 illustrates a block diagram of an electric vehicle.

FIG. 2 is a block cross section of an exemplary variable voltage converter.

FIG. 3 is a pictorial view of an inductor.

FIG. 4 is a top view of a first inductor having two actively cooled winding assemblies.

FIG. 5 is a cross sectional view of one of the winding assemblies of the inductor of FIG. 4.

FIG. 6 is a top view of a second inductor having a different fluid flow pattern than the first inductor.

FIG. 7 is a top view of a third inductor having a different fluid flow pattern than the first and second inductors.

FIG. 8 is a schematic diagram of an electric drive system utilizing an inductor as illustrated in one or more of FIGS. 4-7.

FIG. 9 is a flowchart for a method of fabricating an inductor as illustrated in one or more of FIGS. 4-7.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

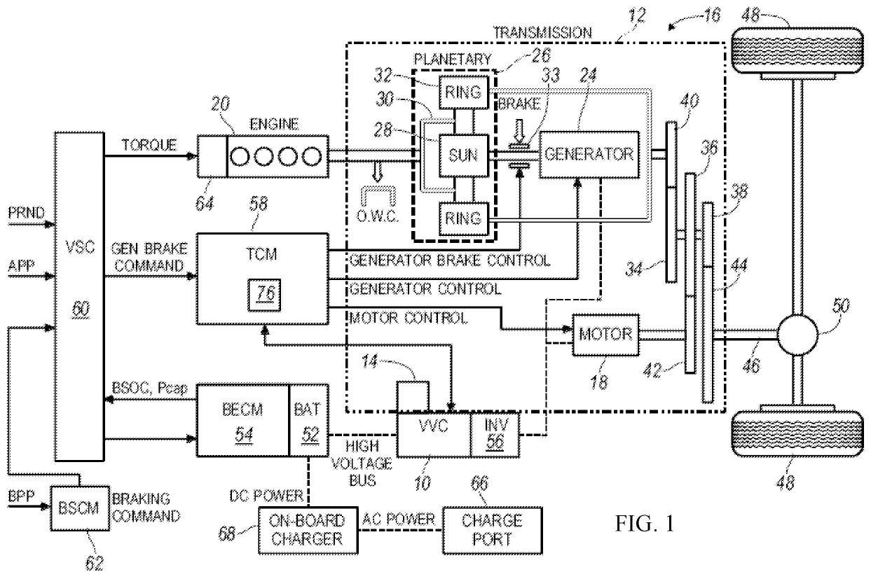

Referring to FIG. 1, a transmission 12 is depicted within a plug-in hybrid electric vehicle (PHEV) 16, which is an electric vehicle propelled by an electric machine 18 with assistance from an internal combustion engine 20 and connectable to an external power grid. The electric machine 18 is an AC electric motor according to one or more embodiments, and depicted as the “motor” 18 in FIG. 1. The electric machine 18 receives electrical power and provides drive torque for vehicle propulsion. The electric machine 18 also functions as a generator for converting mechanical power into electrical power through regenerative braking.

The transmission 12 has a power-split configuration, according to one or more embodiments. The transmission 12 includes the first electric machine 18 and a second electric machine 24. The second electric machine 24 is an AC electric motor according to one or more embodiments, and depicted as the “generator” 24 in FIG. 1. Like the first electric machine 18, the second electric machine 24 receives electrical power and provides output torque. The second electric machine 24 also functions as a generator for converting mechanical power into electrical power and optimizing power flow through the transmission 12.

The transmission 12 includes a planetary gear unit 26, which includes a sun gear 28, a planet carrier 30 and a ring gear 32. The sun gear 28 is connected to an output shaft of the second electric machine 24 for receiving generator torque. The planet carrier 30 is connected to an output shaft of the engine 20 for receiving engine torque. The planetary gear unit 26 combines the generator torque and the engine torque and provides a combined output torque about the ring gear 32. The planetary gear unit 26 functions as a continuously variable transmission, without any fixed or “step” ratios.

The transmission 12 also includes a one-way clutch (OWC) and a generator brake 33, according to one or more embodiments. The OWC is coupled to the output shaft of the engine 20 to only allow the output shaft to rotate in one direction. The OWC prevents the transmission 12 from back-driving the engine 20. The generator brake 33 is coupled to the output shaft of the second electric machine 24. The generator brake 33 may be activated to “brake” or prevent rotation of the output shaft of the second electric machine 24 and of the sun gear 28. In other embodiments, the OWC and the generator brake 33 are eliminated, and replaced by control strategies for the engine 20 and the second electric machine 24.

The transmission 12 includes a countershaft having intermediate gears including a first gear 34, a second gear 36 and a third gear 38. A planetary output gear 40 is connected to the ring gear 32. The planetary output gear 40 meshes with the first gear 34 for transferring torque between the planetary gear unit 26 and the countershaft. An output gear 42 is connected to an output shaft of the first electric machine 18. The output gear 42 meshes with the second gear 36 for transferring torque between the first electric machine 18 and the countershaft. A transmission output gear 44 is connected to a driveshaft 46. The driveshaft 46 is coupled to a pair of driven wheels 48 through a differential 50. The transmission output gear 44 meshes with the third gear 38 for transferring torque between the transmission 12 and the driven wheels 48.

The vehicle 16 includes an energy storage device, such as a battery 52 for storing electrical energy. The battery 52 is a high voltage battery that is capable of outputting electrical power to operate the first electric machine 18 and the second electric machine 24. The battery 52 also receives electrical power from the first electric machine 18 and the second electric machine 24 when they are operating as generators. The battery 52 is a battery pack made up of several battery modules (not shown), where each battery module contains a plurality of battery cells (not shown). Other embodiments of the vehicle 16 contemplate different types of energy storage devices, such as capacitors and fuel cells (not shown) that supplement or replace the battery 52. A high voltage bus electrically connects the battery 52 to the first electric machine 18 and to the second electric machine 24.

The vehicle includes a battery energy control module (BECM) 54 for controlling the battery 52. The BECM 54 receives input that is indicative of vehicle conditions and battery conditions, such as battery temperature, voltage and current. The BECM 54 calculates and estimates battery parameters, such as battery state of charge and the battery power capability. The BECM 54 provides output (BSOC. Pcap) that is indicative of the BSOC and the battery power capability to other vehicle systems and controllers.

The transmission 12 includes a Variable Voltage Control (VVC) 10 and an inverter 56. The VVC 10 and the inverter 56 are electrically connected between the main battery 52 and the first electric machine 18; and between the battery 52 and the second electric machine 24. The VVC 10 “boosts” or increases the voltage potential of the electrical power provided by the battery 52. The VVC 10 also “bucks” or decreases the voltage potential of the electrical power provided by the battery 52, according to one or more embodiments. The inverter 56 inverts the DC power supplied by the main battery 52 (through the VVC 10) to AC power for operating the electric machines 18, 24. The inverter 56 also rectifies AC power provided by the electric machines 18, 24, to DC for charging the main battery 52. Other embodiments of the transmission 12 include multiple inverters (not shown), such as one invertor associated with each electric machine 18, 24.

The transmission 12 includes a transmission control module (TCM) 58 for controlling the electric machines 18, 24, the VVC 10 and the inverter 56. The TCM 58 is configured to monitor, among other things, the position, speed, and power consumption of the electric machines 18, 24. The TCM 58 also monitors electrical parameters (e.g., voltage and current) at various locations within the VVC 10 and the inverter 56. The TCM 58 provides output signals corresponding to this information to other vehicle systems.

The vehicle 16 includes a vehicle system controller (VSC) 60 that communicates with other vehicle systems and controllers for coordinating their function. Although it is shown as a single controller, the VSC 60 may include multiple controllers that may be used to control multiple vehicle systems according to an overall vehicle control logic, or software.

The vehicle controllers, including the VSC 60 and the TCM 58 generally includes any number of microprocessors, ASICs, ICs, memory (e.g., FLASH, ROM, RAM, EPROM and/or EEPROM) and software code to co-act with one another to perform a series of operations. The controllers also include predetermined data, or “look up tables” that are based on calculations and test data and stored within the memory. The VSC 60 communicates with other vehicle systems and controllers (e.g., the BECM 54 and the TCM 58) over one or more wired or wireless vehicle connections using common bus protocols (e.g., CAN and LIN). The VSC 60 receives input (PRND) that represents a current position of the transmission 12 (e.g., park, reverse, neutral or drive). The VSC 60 also receives input (APP) that represents an pedal position. The VSC 60 provides output that represents a desired wheel torque, desired engine speed, and generator brake command to the TCM 58; and contactor control to the BECM 54.

The vehicle 16 includes a braking system (not shown) which includes a brake pedal, a booster, a master cylinder, as well as mechanical connections to the driven wheels 48, to effect friction braking. The braking system also includes position sensors, pressure sensors, or some combination thereof for providing information such as brake pedal position (BPP) that corresponds to a driver request for brake torque. The braking system also includes a brake system control module (BSCM) 62 that communicates with the VSC 60 to coordinate regenerative braking and friction braking. The BSCM 62 provides a regenerative braking command to the VSC 60, according to one embodiment.

The vehicle 16 includes an engine control module (ECM) 64 for controlling the engine 20. The VSC 60 provides output (desired engine torque) to the ECM 64 that is based on a number of input signals including APP, and corresponds to a driver's request for vehicle propulsion.

The vehicle 16 is configured as a plug-in hybrid electric vehicle (PHEV) according to one or more embodiments. The battery 52 periodically receives AC energy from an external power supply or grid, via a charge port 66. The vehicle 16 also includes an on-board charger 68, which receives the AC energy from the charge port 66. The charger 68 is an AC/DC converter which converts the received AC energy into DC energy suitable for charging the battery 52. In turn, the charger 68 supplies the DC energy to the battery 52 during recharging.

Although illustrated and described in the context of a PHEV 16, it is understood that embodiments of the VVC 10 may be implemented on other types of electric vehicles, such as a Hybrid Electric Vehicle (HEV) or a Battery Electric Vehicle (BEV).

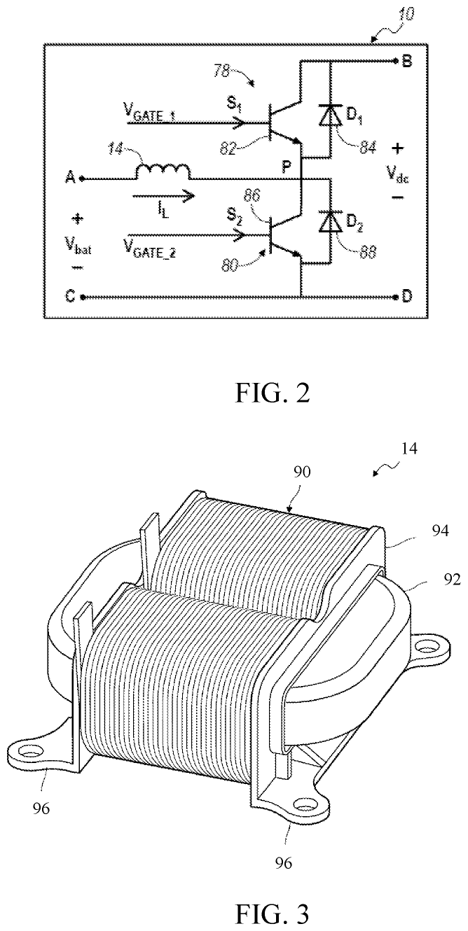

With reference to FIG. 2, the VVC 10 includes a first switching unit 78 and a second switching unit 80 for boosting the battery (input) voltage (V_{bat}) to provide output voltage (V_{dc}). The first switching unit 78 includes a first transistor 82 connected in parallel to a first diode 84, but with their polarities switched (anti-parallel). The second switching unit 80 includes a second transistor 86 connected anti-parallel to a second diode 88. Each transistor 82, 86 may be any type of controllable switch (e.g., an insulated gate bipolar transistor (IGBT) or field-effect transistor (FET)). Additionally, each transistor 82, 86 is individually controlled by the TCM 58. The inductor assembly 14 is depicted as an input inductor that is connected in series between the main battery 52 and the switching units 78, 80. The inductor 14 generates magnetic flux when a current is supplied. When the current flowing through the inductor 14 changes, a time-varying magnetic field is created, and a voltage is induced. Other embodiments of the VVC 10 include different circuit configurations (e.g., more than two switches).

FIG. 3 is a pictorial view of an exemplary inductor 14. Inductor 14 includes electrically conductive windings 90 wrapped around a magnetically conductive core 92. A frame 94 includes mounting provisions 96 for mounting the inductor. The inductor may be mounted remotely from the remainder of the VVC 10, such as inside a transmission case. Heat is generated in the windings when electrical current flows through them and in the core when a magnetic field is established. Transmission fluid may be systematically sprayed on the inductor to dissipate this heat. However, the opportunity for heat removal is limited by the limited external surface area of the windings and the thermal resistance of components between the core and this surface.

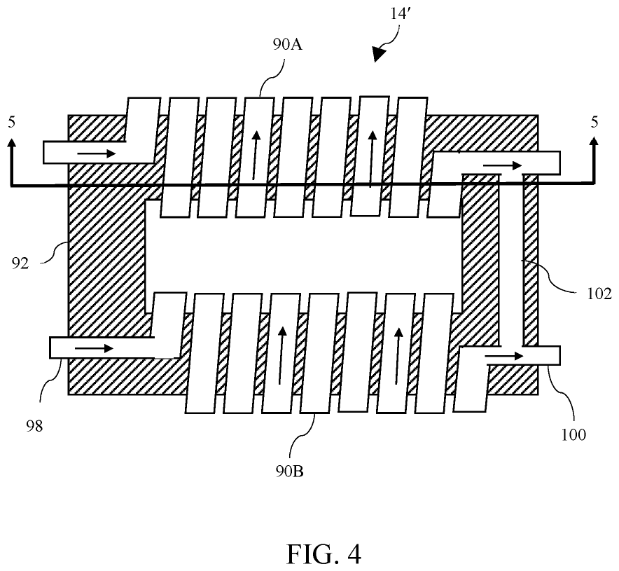

FIG. 4 illustrates an improved inductor 14′ with active cooling of the windings and the core. The core 92 is a ring of magnetically conductive material. Two winding sections 90A and 90B encircle respective straight sections of the core 92. As described more fully below, these winding sections define channels. Each winding section includes an inlet port 98 and an outlet port 100. Fluid, such as Automatic Transmission Fluid (ATF) is directed through the channels as indicated by the arrows. This fluid absorbs heat from the windings and the core. An electrical bridge 102 electrically connects the two winding sections.

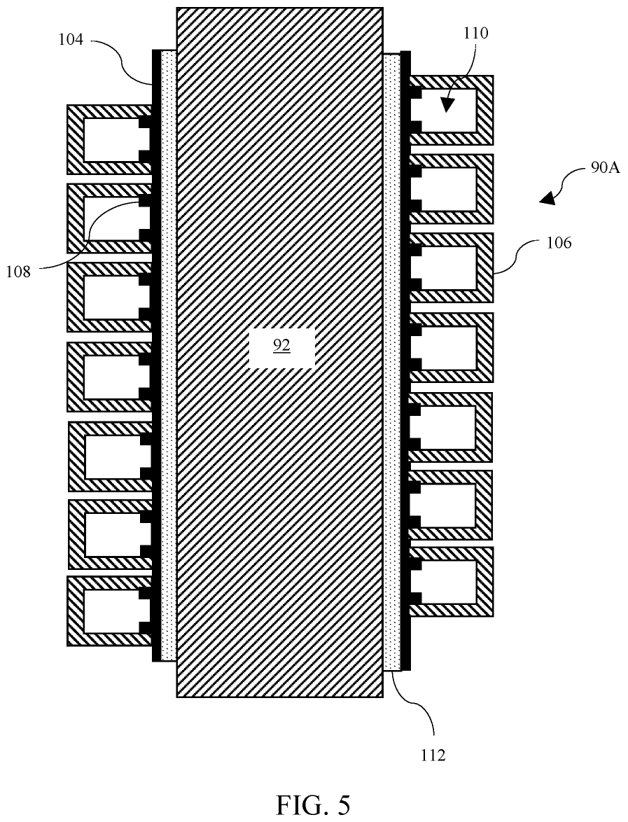

FIG. 5 is a cross section through one of the winding sections that further illustrates the construction of each winding section 90A and 90B. A bobbin 104 encircles the straight section of the core 92. The cross-sectional shape of the bobbin 104 conforms to the cross-sectional shape of the core section. For example, if the core has a rectangular cross section, the bobbin would have a predominantly rectangular cross section, although the corners may be rounded. The inner dimensions of the bobbin are slightly larger than the dimensions of the core such that the bobbin can easily be installed on the core. Wire 106 with a C-shaped cross section is wound around the bobbin. The bobbin may include spiral locating features 108 for the wire 106. The bobbin 104 and the C-shaped wire 106 cooperate to define a channel 110 which runs along the path of the wire. The channel is bounded on three sides by the C-shaped wire and on one side by the outer surface of the bobbin. After the bobbin 104 and wire 106 is installed on the core 92, a plastic layer 112 is injection molded between the core and the bobbin. The plastic 112 binds the bobbin to the core and serves as a thermal conductor to transfer heat from the core to the bobbin. The plastic layer 112 may also exert radial pressure on the bobbin 104 causing it to expand against the windings 106 to seal the channel 110. The inside portion of the winding may become partially embedded into the bobbin.

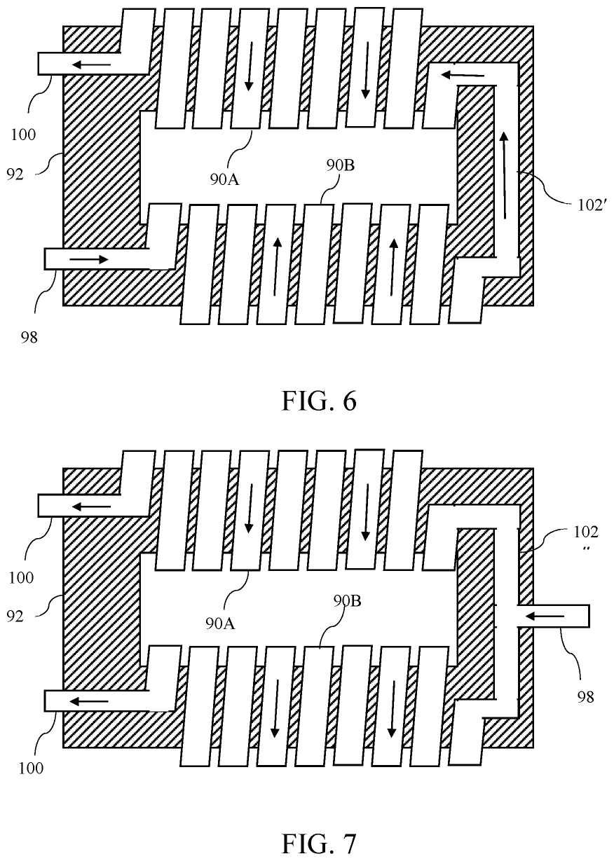

FIGS. 6 and 7 illustrate alternative embodiments with different arrangements of the input and output ports. In the embodiment of FIG. 6, the electrical bridge 102′ defines a channel of its own which connects the channels of winding section 90A and winding section 90B in series. Fluid enters one of the winding sections, flows through the channel defined in that section, then flows through the channel in the electrical bridge, then flows through the channel of the other winding section before exiting. In the embodiment of FIG. 7, electrical bridge 102″ further defines an input port and fluidly connects the channels in parallel (although they are electrically connected in series). Fluid flows into the bridge 102″ and separates into two streams, one of which flows through one winding section and the other of which flows through the other winding section. In other embodiments, the roles of the input port and the output port may be reversed.

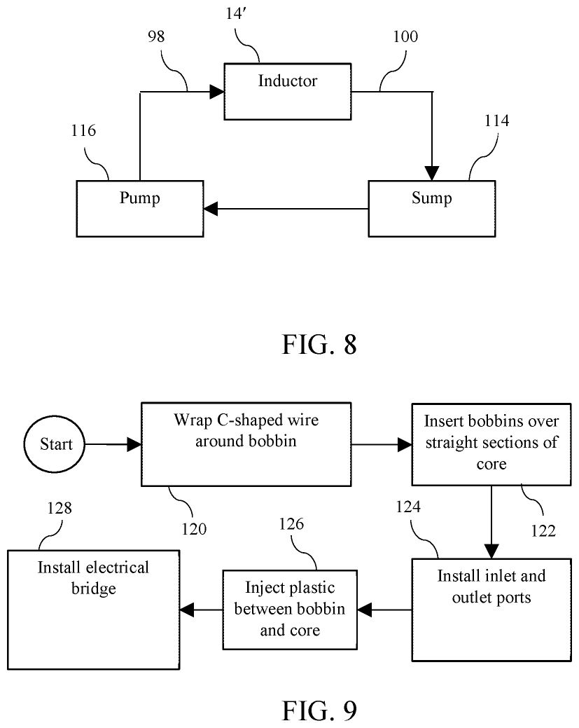

FIG. 8 illustrates how the inductor is actively cooled. ATF is captured in a sump 114 of the transmission case. A pump 116 draws ATF from the sump and routes the ATF to the inlet port 98 of the inductor 14′. After passing through the channel and absorbing heat, the fluid exits via the outlet port 100 and drains back to the sump via gravity.

FIG. 9 illustrates the process for assembling the inductors of FIGS. 4-7. At 120, the C-shaped wire is wrapped around the bobbins, forming the channels. At 122, the bobbins are inserted around straight sections of the core. At 124, the inlet and outlet ports are placed relative to the ends of the channel. At 126, plastic is injected between the core and the bobbins. At 128, the electrical bridge is installed to electrically connect the two winding sections.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. An inductor for an electric drive system, the inductor comprising:
a magnetically conductive core;
a bobbin encircling a section of the core;
an electrically conductive winding encircling the bobbin, the winding and the bobbin defining a channel therebetween; and
an inlet port configured to direct fluid through the channel to cool the inductor.

2. The inductor of claim 1 wherein the electrically conductive winding has a C-shaped cross section with an open side facing the bobbin.

3. The inductor of claim 2 further comprising a plastic filler between the bobbin and the core.

4. The inductor of claim 3 wherein the winding is partially embedded into the bobbin by radially pressure exerted on the bobbin by the plastic filler to seal the winding against the bobbin.

5. The inductor of claim 1 wherein the bobbin includes spiral locating features.

6. An inductor for an electric drive system, the inductor comprising:
a magnetically conductive core having first and second straight sections;
first and second winding assemblies encircling the first and second straight sections respectively, each winding assembly including
a bobbin; and
an electrically conductive winding wrapped around the bobbin defining a channel therebetween; and
an electrical link between the winding of the first winding assembly and the winding of the second winding assembly.

7. The inductor of claim 6 further comprising a plastic filler between each bobbin and the core.

8. The inductor of claim 7 wherein the electrically conductive windings have a C-shaped cross section with an open side facing the respective bobbin.

9. The inductor of claim 8 wherein the windings are partially embedded into the bobbin by radially pressure exerted on the bobbin by the plastic filler to seal the winding against the bobbin.

10. The inductor of claim 6 wherein the bobbins include spiral locating features.

11. The inductor of claim 6 wherein each winding assembly includes an inlet port and an outlet port fluidly connected to the channel.

12. The inductor of claim 6 wherein the electrical link defines a channel which connects the channels of the first and second winding assemblies to one another.

13. The inductor of claim 12 wherein the first winding assembly includes an inlet port and the second winding includes an outlet port such that fluid may be routed from the inlet port, through the channel of the first winding assembly, through the channel of the electrical link, through the channel of the second winding, and then out the outlet port.

14. The inductor of claim 12 wherein the electrical link includes a port and the first and second winding assemblies each include ports.

15. An electric drive system comprising:
a variable voltage converter having an inductor, the inductor comprising:
a magnetically conductive core;
a first bobbin encircling a first straight section of the core;
a first electrically conductive winding wrapped around the first bobbin defining a first channel therebetween; and
a first inlet port fluidly connected to the first channel;
a sump; and
a pump configured to draw fluid from the sump and route it to the first inlet port.

16. The electric drive system of claim 15 wherein the inductor further comprises:
a second bobbin encircling a second straight section of the core;
a second electrically conductive winding wrapped around the second bobbin defining a second channel therebetween; and
an electrical link between the first electrically conductive winding and the second electrically conductive winding.

17. The electric drive system of claim 16 further comprising:
a second inlet port fluidly connected to the second channel;
a first outlet port fluidly connected to the first channel; and
a second outlet port fluidly connected to the second channel.

18. The electric drive system of claim 16 further comprising an outlet port fluidly connected to the second channel, wherein the electrical link defines a fluid channel fluidly connecting the first channel to the second channel.

19. The electric drive system of claim 16 further comprising:
a first outlet port fluidly connected to the first channel; and
a second outlet port fluidly connected to the second channel;
wherein the electrical link defines a fluid channel fluidly connecting the first channel to the second channel and wherein the first inlet port is fluidly connected to the first channel and the second channel via the channel defined in the electrical link.

20. The electric drive system of claim 15 further comprising a plastic filler between the first bobbin and the core, the plastic filler exerting radial pressure on the first bobbin to seal the first bobbin against the first electrically conductive winding.
